(19) United States
(12) Patent Application Publication
(10) Pub. No.: US 2026/0254654 A1
(43) Pub. Date: Aug. 27, 2026

(54) Hardware-Attested Influence-Weighted Oracle Resolution System with TEE-Sealed Provenance Tokens

(71) Applicant: George William Bickerstaff, III, Greenwich, CT (US)

(72) Inventor: George William Bickerstaff, III, Greenwich, CT (US)

(21) Appl. No.: 19/651,726

(22) Filed: Apr. 19, 2026

(51) Int. Cl. H04L 9/32; H04L 9/00; H04L 9/08

(52) U.S. Cl. CPC H04L 9/3239; H04L 9/0825; H04L 9/3213; H04L 9/3252; H04L 9/50

(57) ABSTRACT

A system for resolving prediction market outcomes using secure hardware and trust-based scorer selection. The system scores each resolver based on their track record of accuracy, governance participation, and integrity alignment rather than token holdings. Resolution computations execute inside a tamper-resistant hardware enclave that prevents manipulation by platform operators or external attackers. Upon resolution, the system produces a sealed Provenance Token containing six cryptographic fields that bind the decision to its inputs, scoring model, enclave identity, and a non-replayable counter value, enabling anyone to independently verify resolution integrity. Anomalous resolver submissions are detected and quarantined before consensus using dual machine-learning algorithms running inside the enclave. The system generates regulatory compliance reports within the secure hardware and delivers results through authenticated API endpoints. Settlement automatically distributes payouts to holders of winning outcome shares.

### CROSS-REFERENCE TO RELATED APPLICATIONS

This application is related to the following co-pending applications filed by the same inventor, the entire contents of each of which are incorporated herein by reference: U.S. patent application Ser. No. 19/310,149, filed Aug. 26, 2025, titled “Decentralized Stakeholder Voting Layer for Trust-Weighted Blockchain Governance,” published as US-2025-0391219-A1; U.S. patent application Ser. No. 19/302,048, filed Aug. 6, 2025, titled “PowerRank: System and Method for Verified Influence Scoring”; U.S. patent application Ser. No. 19/560,079, titled “TEE-Attested Federated Stem Cell Therapy Orchestrator”; U.S. patent application Ser. No. 19/567,239, titled “Attested Decision Provenance System for Hardware-Isolated AI Execution”; and U.S. patent application Ser. No. 19/547,066, titled “Trust-State Credit and Capital Markets Infrastructure Layer with Hardware-Anchored Risk Weighting and Attestation-Bound Settlement.”

### FIELD OF THE INVENTION

This invention relates to hardware-isolated execution infrastructure for prediction market oracle resolution within distributed blockchain networks. The system is configured to improve prediction market network performance across four technical dimensions: (i) oracle resolution integrity through hardware attestation, (ii) resolver selection accuracy through influence-weighted trust scoring, (iii) resolution provenance verifiability through cryptographically sealed attestation tokens, and (iv) regulatory auditability through TEE-generated compliance records. The system addresses five technical deficiencies in prior art prediction market oracle architectures: (a) software-only oracle resolution is susceptible to runtime manipulation by platform operators or compromised node software; (b) token-weighted resolver selection introduces plutocratic bias where resolver influence is determined by capital holdings rather than demonstrated prediction accuracy; (c) the absence of hardware-attested provenance records for resolution decisions creates an auditability gap preventing independent verification of resolution integrity; (d) the absence of a structured regulatory reporting interface prevents automated generation of compliance records required by commodities regulators; and (e) the absence of monotonic counter enforcement within the resolution execution environment permits replay attacks on resolution decisions.

### BACKGROUND OF THE INVENTION

Prediction markets are blockchain-based platforms enabling participants to trade shares representing the probability of future event outcomes. Market prices aggregate distributed information and produce probabilistic forecasts used by financial institutions, media organizations, and policymakers. Prediction market platforms operating as Designated Contract Markets under the U.S. Commodity Futures Trading Commission (CFTC) are required to maintain market surveillance capabilities, self-regulatory infrastructure, and auditable resolution mechanisms.

First, existing prediction market oracle resolution systems execute outcome determination in software-only environments without hardware isolation. Resolution logic—including vote tallying, dispute adjudication, and settlement computation—executes in standard virtual machine environments where the platform operator, compromised node software, or co-located malicious processes can observe, modify, or replay resolution computations. No existing prediction market oracle produces a hardware-attested proof that the resolution computation executed within a tamper-resistant enclave using verified code and unmodified inputs.

Second, existing oracle resolver selection mechanisms assign resolver weight in proportion to token holdings, creating plutocratic bias. A single entity acquiring a large token position can dominate resolution outcomes regardless of that entity's demonstrated prediction accuracy, governance participation history, or alignment with market integrity objectives. No existing prediction market oracle weights resolver influence using verified multi-dimensional behavioral metrics computed from on-chain contribution records.

Third, existing prediction market oracle systems do not produce provenance tokens that cryptographically bind the resolution decision to the specific inputs, model parameters, enclave measurement, and monotonic counter state that produced it. Without such binding, post-hoc verification of resolution integrity requires trusting the platform operator's records rather than independently verifiable cryptographic proofs.

Fourth, existing prediction market oracle systems do not generate structured regulatory compliance records within the hardware-isolated execution environment. CFTC-regulated Designated Contract Markets are required to produce auditable records of market resolution activity, but existing systems generate these records in software-only environments where the records can be modified after generation.

Fifth, existing prediction market oracle systems do not enforce monotonic counter constraints within the resolution execution environment, permitting replay attacks in which a prior resolution computation is re-executed with different inputs to produce an alternative outcome.

The following table summarizes key prior art and their limitations, verified through patent database searches (USPTO Patent Public Search and Google Patents, April 2026):
Reference 1: US20170046689A1 (2017 )—“Crypto voting and social aggregating”—General cryptographic voting without hardware attestation or influence-weighted resolver selection. Verified via USPTO.
Reference 2: US20200258338A1(2020 )—“Secure voting system”—Basic blockchain voting without TEE execution, provenance tokens, or resolver trust scoring. Verified via Google Patents.
Reference 3: US10360191B2(2019 )—“Establishing overlay trust consensus for blockchain”—Blockchain consensus without hardware-isolated execution or sealed provenance token generation. Verified via USPTO.
Reference 4: U.S. Pat. No. 12,531,741 (Thompson, 2025)—Blockchain governance system—Token-weighted voting without influence-based resolver selection, TEE attestation, or Provenance Token generation. Filed Sep. 17, 2025; does not disclose hardware-attested resolution, influence-weighted resolver trust scoring, or six-field sealed provenance tokens. Verified via USPTO.
Reference 5: UMA Protocol (2020-present)—Optimistic oracle with token-weighted dispute resolution—Token-staked voting without hardware isolation, influence scoring, or provenance token generation. Resolution executes in software-only environments.

These prior arts advance cryptographic voting, consensus, and dispute resolution but fail to provide a comprehensive system for hardware-attested prediction market resolution with influence-weighted resolver selection and cryptographically sealed provenance tokens. This invention addresses these gaps.

### SUMMARY OF THE INVENTION

The system is a Hardware-Attested Influence-Weighted Oracle Resolution System that functions as a resolution infrastructure layer within a prediction market blockchain network. The system comprises five interconnected hardware-and-software components that together carry out a five-stage method: aggregating resolver influence metrics, computing influence-weighted resolver trust scores, executing oracle resolution within a Trusted Execution Environment, generating sealed provenance tokens, and delivering resolution decisions with regulatory compliance records through a structured integration interface.

The disclosed system operates as a resolution-processing control layer within a prediction market network, wherein resolution transactions are selectively filtered and weighted prior to entry into settlement queues, and resolution computations execute within hardware-isolated enclaves producing cryptographic attestation proofs. The system enforces admission control constraints within the resolver selection pipeline such that only resolvers satisfying defined influence-weighted trust thresholds are eligible to participate in resolution consensus. The system further enforces execution integrity constraints within the TEE such that resolution computations produce verifiable attestation records binding the decision to inputs, code measurement, and monotonic counter state.

The system is distinguished from prior art by the specific combination of five technical mechanisms: (1) a three-variable Influence Trust Score formula with coefficients iteratively updated by a gradient-boosted tree classifier trained on historical resolution accuracy data through gradient-descent optimization; (2) TEE-isolated execution of resolution computations using Intel SGX or ARM TrustZone enclaves with remote attestation verification; (3) generation of sealed Provenance Tokens comprising six cryptographic fields binding each resolution to its inputs, model, decision, enclave measurement, monotonic counter state, and an ECDSA signature over the concatenated hash chain; (4) concurrent execution of isolation forest and DBSCAN anomaly detection algorithms on the resolver submission stream prior to resolution consensus, both executing within the TEE; and (5) a structured Regulatory Compliance API with three defined RESTful endpoints producing CFTC-formatted audit records generated within the TEE.

### BRIEF DESCRIPTION OF THE DRAWINGS

The drawings illustrate embodiments of the invention and are submitted as separate sheets in compliance with 37 C.F.R. § 1.84. All figures are black-and-white line drawings with clear labels and reference numerals.

FIG. 1 is a block diagram of the Resolver Influence Aggregator (100) comprising Market Data Inputs (110), Aggregation Unit (120), Privacy Filter (130), Source Verifier (140), and Influence Classifier (150).

FIG. 2 is a flowchart of the Influence Trust Scoring Engine (200) comprising Metric Evaluation (210), Weight Assignment (220), Influence Trust Scoring (230), Weight Adjustment (240), and Accuracy Feedback Loop (250).

FIG. 3 is a block diagram of the TEE Resolution Processor (300) comprising Enclave Initialization (310), Resolution Validation (320), Consensus Execution (330), Anomaly Detection (340), and Provenance Token Generation (350).

FIG. 4 is a flowchart of the Attestation and Settlement Module (400) comprising Attestation Verification (410), Settlement Compilation (420), Timestamp Binding (430), Immutable Ledger Storage (440), and Audit Encryption (450).

FIG. 5 is a flowchart of the Regulatory Compliance Output Layer (500) comprising Decision Delivery (510), Encryption Unit (520), Compliance API (530), Report Formatting (540), and Secure Transmission (550).

### LIST OF FIGURES WITH REFERENCE NUMBERS

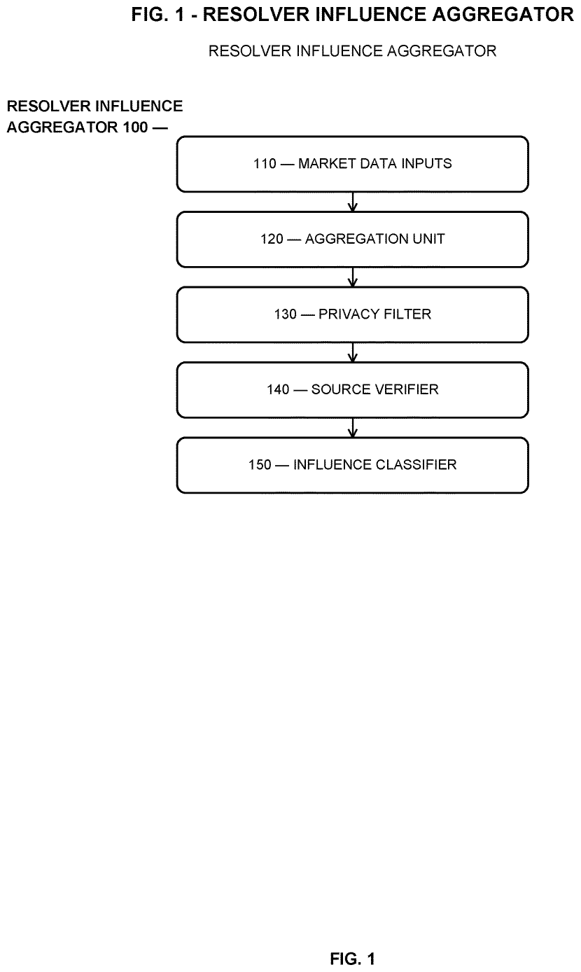

### FIG. 1: Resolver Influence Aggregator

100: Resolver Influence Aggregator
110: Market Data Inputs
120: Aggregation Unit
130: Privacy Filter
140: Source Verifier
150: Influence Classifier

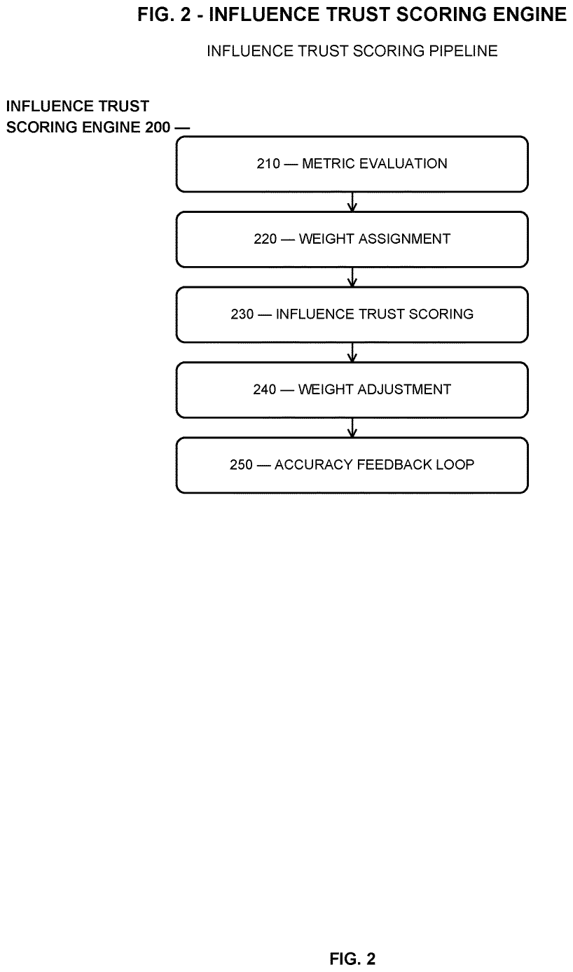

### FIG. 2: Influence Trust Scoring Engine

200: Influence Trust Scoring Engine
210: Metric Evaluation
220: Weight Assignment
230: Influence Trust Scoring
240: Weight Adjustment
250: Accuracy Feedback Loop

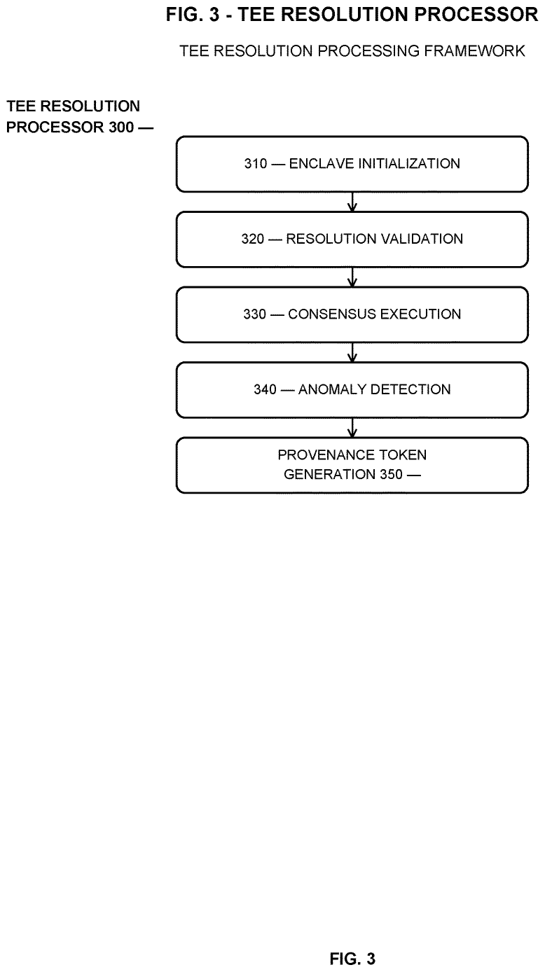

### FIG. 3: TEE Resolution Processor

300: TEE Resolution Processor
310: Enclave Initialization
320: Resolution Validation
330: Consensus Execution
340: Anomaly Detection
350: Provenance Token Generation

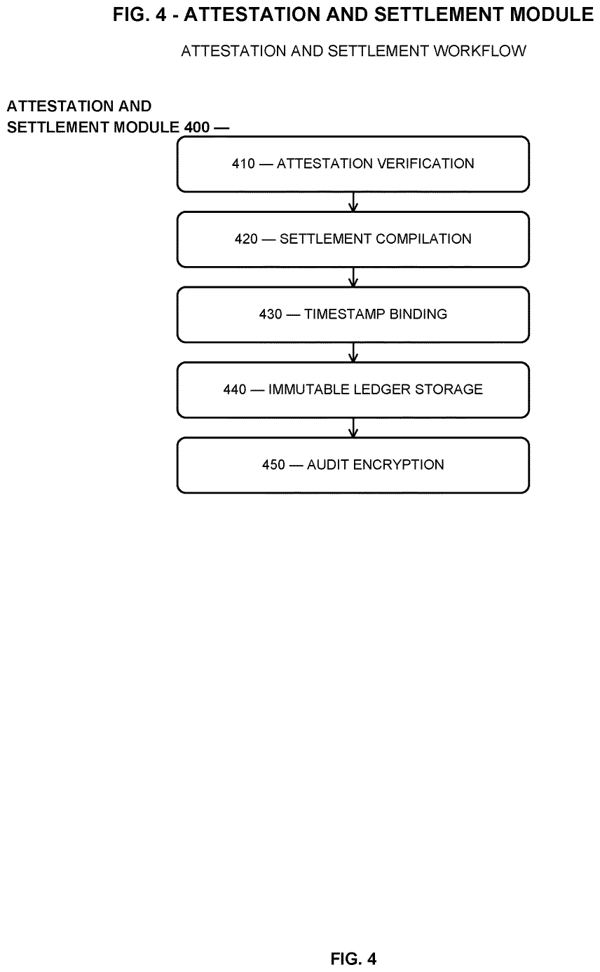

### FIG. 4: Attestation and Settlement Module

400: Attestation and Settlement Module
410: Attestation Verification
420: Settlement Compilation
430: Timestamp Binding
440: Immutable Ledger Storage
450: Audit Encryption

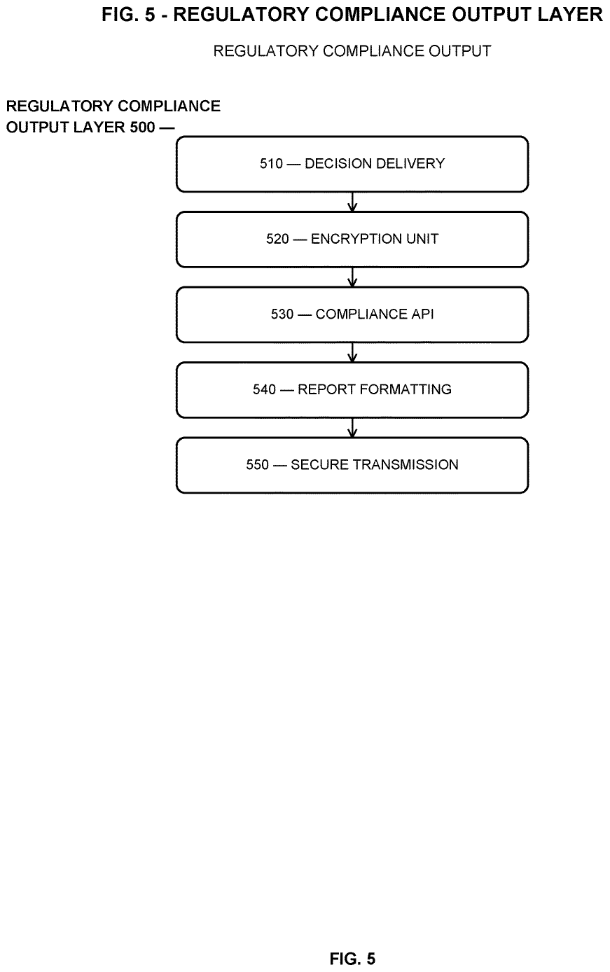

### FIG. 5: Regulatory Compliance Output Layer

500: Regulatory Compliance Output Layer
510: Decision Delivery
520: Encryption Unit
530: Compliance API
540: Report Formatting
550: Secure Transmission

### Definitions

For clarity and accurate interpretation, the following terms are defined as used in this specification (sorted alphabetically):
“Anomaly Detection Algorithm”: a machine-learning method, including isolation forests and DBSCAN clustering, applied to resolver submission data to identify submissions that deviate from established patterns in a manner indicative of coordinated manipulation, sybil attack, or unauthorized resolver participation.
“Designated Contract Market”: a trading facility registered with the U.S. Commodity Futures Trading Commission (CFTC) under Section 5 of the Commodity Exchange Act, subject to self-regulatory obligations including market surveillance, record-keeping, and auditable resolution of event-based contracts.
“Enclave Measurement”: a cryptographic hash (MRENCLAVE in Intel SGX implementations) of the code, data, and configuration loaded into a Trusted Execution Environment at initialization, uniquely identifying the software executing within the enclave and enabling remote attestation of code integrity.
“Influence Trust Score”: a composite numerical value computed from Resolver Influence Metrics using a weighted aggregation formula, representing the degree of weight assigned to a given resolver's vote in an oracle resolution decision, derived from demonstrated prediction accuracy, governance participation, and market integrity alignment rather than token holdings.
“Market Resolution”: the process of determining the outcome of a prediction market event contract, including collection of resolver votes, consensus computation, settlement price determination, and distribution of payouts to holders of winning outcome shares.
“Monotonic Counter”: a hardware-enforced counter within a Trusted Execution Environment that increments with each resolution execution and cannot be decremented or reset by software, firmware, or operating system processes, preventing replay of prior resolution computations by ensuring each resolution is bound to a unique, strictly increasing counter value.
“Oracle Resolver”: a participant in the prediction market resolution process who submits an outcome determination vote, weighted by the Influence Trust Score, and whose submission is subject to anomaly detection and TEE-attested consensus processing.
“Prediction Market”: a blockchain-based trading platform where participants buy and sell shares representing the probability of specific future event outcomes, with share prices ranging from zero to one dollar and settling at one dollar for the correct outcome and zero for incorrect outcomes upon market resolution.
“Provenance Token”: a cryptographically sealed data structure generated within a Trusted Execution Environment comprising six fields: (i) INPUT_HASH: a SHA-256 hash of resolution inputs; (ii) MODEL_HASH: a SHA-256 hash of resolution model parameters; (iii) DECISION_HASH: a SHA-256 hash of the resolution decision; (iv) ENCLAVE_MEASUREMENT: the MRENCLAVE value; (v) COUNTER_VALUE: the monotonic counter value; and (vi) SIGNATURE: an ECDSA signature computed over the concatenated hash chain SHA-256(INPUT_HASH∥MODEL_HASH∥DECISION_HASH∥ENCLAVE_MEASUREMENT∥COUNTER_VALUE), collectively providing independently verifiable proof that a specific resolution decision was produced by verified code operating on verified inputs within a tamper-resistant hardware enclave at a specific non-replayable counter state.
“Remote Attestation”: a cryptographic protocol by which a Trusted Execution Environment proves to a remote verifier that a specific software configuration is executing within a genuine hardware enclave, using manufacturer-signed attestation reports containing the Enclave Measurement and platform identity.
“Resolution Accuracy Score”: a numerical value representing a resolver's historical accuracy in correctly determining prediction market outcomes, computed as the ratio of correctly resolved markets to total markets participated in, weighted by market liquidity and recency.
“Resolver Influence Metrics”: quantitative measures of a resolver's demonstrated reliability in prediction market resolution processes, comprising Resolution Accuracy Score, Governance Participation Metric, and Market Integrity Alignment Metric, derived from verifiable on-chain contribution records.
“Trusted Execution Environment (TEE)”: a hardware-isolated processing region within a processor, including Intel Software Guard Extensions (SGX) and ARM TrustZone implementations, that provides confidentiality and integrity protection for code and data executing within the enclave, preventing observation or modification by the operating system, hypervisor, or other software outside the enclave boundary.
“Zero-Knowledge Proof (ZKP)”: a cryptographic protocol by which one party proves to another that a statement is true without conveying any information beyond the validity of the statement itself, enabling verification of resolver eligibility without disclosure of resolver identity or submission content.

### Detailed Description of the Invention

The following detailed description explains how to make and use the Hardware-Attested Influence-Weighted Oracle Resolution System. The description is organized by component corresponding to the five components identified in the Summary of the Invention. Specific algorithms, data formats, threshold values, cryptographic standards, and TEE implementation parameters are identified throughout so that a person of ordinary skill in distributed computing, blockchain systems, and hardware security can implement the invention without undue experimentation. Default parameter ranges, threshold values, and model update intervals are stored as configurable system parameters and may be adjusted without altering the functional operation of the system. Modifications may be made within the scope of the invention without departing from its principles.

### I. System Overview

As shown in FIGS. 1-5, the system operates within a prediction market blockchain network as a resolution-processing control layer that enforces admission control and execution integrity constraints within the oracle resolution pipeline. It receives Resolver Influence Metric data from blockchain ledgers—including on-chain resolution histories, market participation records, and verified governance contribution logs—and from authorized external data providers. The system processes that data through five components described below and outputs cryptographically attested resolution decisions, sealed Provenance Tokens, and regulatory compliance records through authenticated Compliance API endpoints. The five components execute sequentially for each market resolution cycle and pass data through defined interfaces.

The system is designed to process oracle resolution votes for prediction market platforms, including platforms operating as Designated Contract Markets. Example applications include binary outcome resolution for political event contracts, multi-outcome resolution for economic indicator contracts, continuous resolution for weather derivative contracts, and dispute escalation resolution for contested market outcomes.

The system is distinguished from prior art prediction market oracle systems by the specific combination of five technical mechanisms described in paragraph [0013], collectively enforcing admission control and execution integrity constraints such that only resolver submissions satisfying defined influence-weighted trust thresholds, anomaly detection criteria, and TEE execution requirements are eligible for inclusion in resolution consensus and settlement.

### II. Component 1: Resolver Influence Aggregator (100)

The Resolver Influence Aggregator, illustrated in FIG. 1 with reference numeral 100, is the first component of the system. Its function is to ingest Resolver Influence Metrics from diverse sources, normalize those metrics, filter them for privacy compliance, verify their authenticity, and classify them for processing by the Influence Trust Scoring Engine.

Market Data Inputs (110): The Resolver Influence Aggregator receives three categories of Resolver Influence Metrics: (a) Resolution Accuracy Scores derived from verifiable on-chain resolution histories including historical market resolution accuracy rates weighted by market liquidity measured in total traded volume and recency measured as an exponential decay function with a configurable half-life defaulting to 180 days; (b) Governance Participation Metrics calculated from the frequency, recency, and quality of governance interactions including dispute resolution participation, market parameter voting, and protocol upgrade contributions over a configurable preceding time window defaulting to 365 days; and (c) Market Integrity Alignment Metrics derived from the degree of correspondence between a resolver's past resolution decisions and independently verified ground-truth outcomes recorded by authorized data providers including the Associated Press, Reuters, and Bloomberg for political and economic events. All inputs are received in JSON format through authenticated input channels secured with TLS 1.3 mutual authentication.

Aggregation Unit (120): The Aggregation Unit normalizes multi-format inputs using the following steps: (a) parsing received JSON payloads to extract field values corresponding to the three metric categories; (b) applying min-max normalization to each metric category using the formula normalized_value=(raw_value−category_minimum)/(category_maximum−category_minimum), producing values on a zero-to-one scale; (c) concatenating the three normalized values per resolver into a standardized three-dimensional metric vector [Resolution_Accuracy, Governance_Participation, Market_Integrity]; and (d) logging each input with a SHA-256 cryptographic hash of the raw payload for audit purposes. Category minimum and maximum values are recomputed at configurable intervals defaulting to every 100 resolution cycles.

Privacy Filter (130): The Privacy Filter applies pseudonymization to each resolver metric record before the record is stored or transmitted. Direct resolver identifiers including wallet addresses are replaced with pseudonymous identifiers generated using SHA-256 hashing with a system-controlled 256-bit salt rotated at configurable intervals. Metric values below a configured minimum aggregation threshold defaulting to five resolution participations are suppressed to prevent individual-level inference. The mapping between pseudonymous identifiers and actual resolver identities is stored exclusively within the TEE's sealed storage region and is accessible only through attested enclave operations requiring remote attestation verification. In alternative embodiments, the Privacy Filter may employ Zero-Knowledge Proofs to verify resolver eligibility criteria without disclosing resolver identity or submission content.

Source Verifier (140): For on-chain data, the Source Verifier retrieves the relevant blockchain transaction record and verifies the transaction signature against the originating account's public key using ECDSA verification on the secp256k1 curve. For off-chain data from authorized data providers, it requires a Decentralized Identifier (DID) credential conforming to the W3C DID Core Specification, signed by an authorized certification authority whose public key is registered in the system's trust registry. Records failing signature verification or presenting DID credentials not found in the trust registry are rejected with a logged rejection code.

Influence Classifier (150): The Influence Classifier categorizes normalized, filtered, verified metric vectors using k-means clustering applied to the three-dimensional metric vector space, with a default of k=5 clusters representing distinct resolver participation profiles: (i) novice resolvers with fewer than 10 resolved markets; (ii) developing resolvers with 10-50 resolved markets; (iii) established resolvers with 50-200 resolved markets; (iv) senior resolvers with 200-500 resolved markets; and (v) expert resolvers with over 500 resolved markets and resolution accuracy above 0.85. Cluster centroids are recomputed after each batch of 100 resolution cycles. The cluster assignment determines the initial weight coefficient set applied by the Influence Trust Scoring Engine.

### III. Component 2: Influence Trust Scoring Engine (200)

The Influence Trust Scoring Engine, illustrated in FIG. 2 with reference numeral 200, is the second component of the system. It computes an Influence Trust Score for each resolver from the classified metric vectors, assigns a corresponding resolution weight, and refines the weighting model through iterative machine-learning training using resolution accuracy feedback. The Influence Trust Scoring Engine processes inputs before they reach the resolution validation stage, reducing the influence of low-accuracy or manipulated-weight inputs earlier in the resolution processing flow.

Metric Evaluation (210): A gradient-boosted tree classifier (XGBoost implementation with 100 estimators, maximum depth of 6, and learning rate of 0.1) trained on historical resolution accuracy data labeled with resolver performance categories evaluates the three normalized metric values and outputs a trust level category—LOW, MEDIUM, HIGH, or EXPERT—for each resolver. The classifier is trained on a minimum of 1,000 historical resolution records before deployment, with retraining triggered by the Accuracy Feedback Loop.

Weight Assignment (220): Based on the trust level category and the k-means cluster assignment, the Weight Assignment step applies a configurable weight coefficient matrix. Default base weights are: LOW trust=0.1; MEDIUM trust=0.4; HIGH trust=0.8; EXPERT trust=1.0. These base weights are further adjusted by cluster-specific multipliers in the range [0.5, 1.5] learned through the Accuracy Feedback Loop. The resulting resolution weight is a floating-point value in the range [0.05, 1.5].

Influence Trust Scoring (230): The Influence Trust Scoring step computes a composite Influence Trust Score using the formula: Influence_Trust_Score=(w_a×Resolution_Accuracy_Score)+(w_g ×Governance_Participation_Metric)+(w_m×Market_Integrity_Alignment_Metric), where w_a, w_g, and w_m are weighting coefficients stored in the TEE's sealed storage region and updated by the Accuracy Feedback Loop. Default coefficient values are w_a=0.50, w_g=0.25, and w_m=0.25, which sum to 1.0. The computed Influence Trust Score is stored in the TEE's sealed storage as a binding parameter and is programmatically enforced during resolution validation, such that submissions from resolvers with Influence Trust Scores below a configured minimum threshold defaulting to 0.20 are rejected prior to entering resolution consensus. The stored Influence Trust Score is retrieved during resolution validation through a deterministic lookup operation performed by the TEE Resolution Processor prior to execution of the resolution consensus.

Weight Adjustment (240): Real-time corrections to computed resolution weights are applied when new resolver metric data becomes available after initial weight assignment but before the resolution period closes. Each correction is logged with a UTC timestamp, a SHA-256 hash of the prior weight value, the new weight value, and a TEE attestation proof linking the correction to the enclave's current Enclave Measurement.

Accuracy Feedback Loop (250): After each completed market resolution cycle, the Accuracy Feedback Loop updates model parameters by: (a) receiving resolution outcome records including which resolvers submitted, what weights were applied, the influence-weighted consensus outcome, and the verified ground-truth outcome from authorized data providers; (b) computing a resolution accuracy error metric defined as the mean squared error between the influence-weighted consensus probability vector and the binary ground-truth outcome vector; (c) executing a gradient-descent optimization pass with a learning rate of 0.01 over the weight coefficients w_a, w_g, and w_m to minimize the accuracy error metric, subject to the constraint that w_a+w_g+w_m=1.0 and each coefficient remains in the range [0.10, 0.70]; (d) updating model parameters of the gradient-boosted tree classifier by appending the completed resolution cycle's training data to the historical training set and retraining with early stopping at 10 rounds without improvement; and (e) storing updated model parameters in the TEE's sealed storage region. The Accuracy Feedback Loop executes automatically upon resolution cycle completion without requiring manual intervention.

### IV. Component 3: TEE Resolution Processor (300)

The TEE Resolution Processor, illustrated in FIG. 3 with reference numeral 300, is the third component of the system. It executes all resolution computations within a hardware-isolated Trusted Execution Environment, validates resolver submissions, achieves distributed agreement through resolution consensus, detects anomalous resolver submissions, and generates sealed Provenance Tokens for each resolution decision. In the processing flow, the TEE Resolution Processor operates after the Influence Trust Scoring Engine has computed Influence Trust Scores, receiving submissions that already carry influence-weighted resolution weights.

Enclave Initialization (310): At system startup and before each resolution cycle, the TEE Resolution Processor initializes a hardware-isolated enclave. The initialization procedure: (a) loads the resolution computation code into the enclave memory region, which is inaccessible to the operating system, hypervisor, and all other software outside the enclave boundary; (b) computes the Enclave Measurement (MRENCLAVE in Intel SGX implementations) as a SHA-256 hash of the loaded code pages, data pages, heap configuration, and stack configuration; (c) generates a remote attestation report signed by the hardware manufacturer's attestation key (Intel EPID or DCAP for SGX implementations, or platform attestation key for ARM TrustZone implementations); (d) reads the current monotonic counter value from the hardware-enforced counter; and (e) verifies that the current monotonic counter value is strictly greater than the value recorded for the previous resolution cycle. If the monotonic counter check fails, the enclave aborts initialization, logs a replay attack alert with the expected and observed counter values, and refuses to process the resolution cycle.

Resolution Validation (320): Each resolver submission is validated within the enclave against five predefined resolution rules: (a) the resolver's pseudonymous identifier must be present in the registered resolver list for the active market, stored in the TEE's sealed storage; (b) the resolution weight field must match the value stored in the TEE's sealed storage, retrieved through a deterministic lookup operation, and submissions with weights deviating from the stored Influence Trust Score are rejected prior to entering consensus—this enforcement prevents resolvers from self-assigning inflated weights; (c) the resolution vote must correspond to one of the enumerated outcome options defined in the market contract deployed on the blockchain; (d) the ECDSA digital signature must verify correctly against the resolver's registered public key using the secp256k1 curve; and (e) no prior submission from the same pseudonymous identifier may be recorded for the active market resolution. Submissions failing any validation check are rejected with a logged rejection code and reason.

Consensus Execution (330): The system supports three resolution consensus implementations selectable by market configuration: (a) Weighted Majority, in which the outcome receiving the highest sum of influence-weighted resolver votes is selected, with a minimum participation threshold defaulting to 60% of eligible resolver weight; (b) Supermajority Threshold, in which an outcome must receive at least two-thirds of the total weighted resolver votes to be confirmed as the resolution; and (c) Tiered Escalation, in which automated resolution using data from an authorized data provider is attempted first, followed by resolver consensus for disputed outcomes where at least one resolver with an Influence Trust Score above a configured dispute threshold defaulting to 0.70 submits a challenge, and human arbitration escalation for outcomes where resolver consensus fails to reach the supermajority threshold within a configured time window defaulting to 72 hours. All consensus computation executes within the TEE enclave, ensuring that intermediate consensus state is not observable by processes outside the enclave boundary.

Anomaly Detection (340): The Anomaly Detection submodule executes two anomaly detection algorithms concurrently on the stream of incoming resolver submissions during the resolution period, operating as a gating mechanism prior to consensus computation that prevents flagged submissions from entering the consensus pipeline. Both algorithms execute within the TEE. The two algorithms are: (a) an isolation forest algorithm (scikit-learn implementation with 200 estimators and a contamination parameter of 0.05) trained on historical resolver submission patterns including submission timing, weight distribution, and outcome clustering, which assigns an anomaly score between 0.0 and 1.0 to each submission, with submissions scoring above a configured threshold defaulting to 0.75 flagged as anomalous; and (b) a DBSCAN (Density-Based Spatial Clustering of Applications with Noise) algorithm with epsilon parameter defaulting to 0.3 and minimum samples parameter defaulting to 3, applied to the multidimensional submission feature space including submission timestamp, resolver wallet creation date, historical resolution participation count, and outcome vote, which identifies density-based clusters of correlated resolver submissions and classifies submissions outside established population clusters as potentially coordinated or sybil-originated. Submissions flagged by either algorithm are quarantined within the enclave and excluded from consensus computation unless affirmatively released through a manual review process requiring TEE-attested authorization. The concurrent dual-algorithm architecture improves detection coverage relative to single-algorithm approaches based on the complementary detection characteristics of isolation forest (detecting individual outliers) and DBSCAN (detecting coordinated clusters).

Provenance Token Generation (350): Upon completion of resolution consensus, the TEE Resolution Processor generates a sealed Provenance Token comprising six fields, all computed within the hardware-isolated enclave: (a) INPUT_HASH: a SHA-256 hash of the concatenated resolver submissions admitted to consensus, ordered by pseudonymous identifier; (b) MODEL_HASH: a SHA-256 hash of the current Influence Trust Scoring model parameters including the weight coefficients w_a, w_g, w_m and the serialized gradient-boosted tree classifier state; (c) DECISION_HASH: a SHA-256 hash of the resolution decision record including the selected outcome identifier, weighted vote totals per outcome, total participation weight, and participation rate; (d) ENCLAVE_MEASUREMENT: the MRENCLAVE value computed at enclave initialization in step (310); (e) COUNTER_VALUE: the current monotonic counter value, which is incremented within the hardware counter immediately after Provenance Token signature computation and before any data exits the enclave; and (f) SIGNATURE: an ECDSA signature computed within the enclave over the concatenated hash chain SHA-256(INPUT_HASH∥MODEL_HASH∥DECISION_HASH∥ENCLAVE_MEASUREMENT∥COUNTER_VALUE) using the enclave's attestation signing key derived from the platform's hardware root of trust. The Provenance Token is published to the blockchain public ledger alongside the resolution decision record, enabling any network participant to independently verify that the resolution was produced by verified code (ENCLAVE_MEASUREMENT), operating on verified inputs (INPUT_HASH), using a verified model (MODEL_HASH), producing a specific decision (DECISION_HASH), within a genuine hardware enclave (verified through Remote Attestation), at a specific non-replayable execution sequence (COUNTER_VALUE).

### V. Component 4: Attestation and Settlement Module (400)

The Attestation and Settlement Module, illustrated in FIG. 4 with reference numeral 400, is the fourth component of the system. It independently verifies the Provenance Token attestation, compiles settlement records for market participants, records blockchain-generated timestamps, stores all records in Immutable Storage, and protects internal audit logs through asymmetric encryption.

Attestation Verification (410): Before settlement execution, the Attestation Verification step independently verifies the Provenance Token by: (a) retrieving the enclave's remote attestation report from the hardware manufacturer's attestation service (Intel Attestation Service for SGX EPID, or the DCAP verification library for SGX DCAP); (b) confirming that the ENCLAVE_MEASUREMENT in the Provenance Token matches the measurement value in the manufacturer's attestation report, thereby verifying code integrity; (c) verifying the ECDSA SIGNATURE over the concatenated hash chain SHA-256(INPUT_HASH∥MODEL_HASH∥DECISION_HASH∥ENCLAVE_MEASUREMENT∥COUNTER_VALUE) using the enclave's public attestation key; and (d) confirming that the COUNTER_VALUE is strictly greater than the value recorded for the previous resolution cycle, thereby confirming non-replay. Settlement proceeds only if all four verification checks pass. If any check fails, settlement is halted and a verification failure alert is logged with the specific failing check identified.

Settlement Compilation (420): The Settlement Compilation step generates settlement instructions for each market participant by computing payout amounts based on the resolution decision. Winning outcome shares settle at one dollar ($1.00) per share; losing outcome shares settle at zero ($0.00). Settlement instructions are structured as a JSON array of payout records, each containing the participant's pseudonymous identifier, outcome share position, payout amount, and a reference to the resolution's Provenance Token.

Timestamp Binding (430): Records the completion time of each resolution and settlement using a blockchain-generated timestamp derived from the block header of the block in which the resolution record and Provenance Token are published, set by the network's consensus nodes. The timestamp is included in the immutable resolution record.

Immutable Ledger Storage (440): Each resolution record, Provenance Token, and settlement instruction is hashed using SHA-256 and that hash is incorporated into the subsequent block's header on the blockchain, making undetected alteration computationally infeasible without controlling a majority of the network's consensus nodes. The storage architecture is append-only, preventing deletion or modification of historical resolution records.

Audit Encryption (450): The internal audit log for each resolution cycle—including quarantined submission records, anomaly detection feature vectors and scores, TEE attestation reports, and Accuracy Feedback Loop training metrics—is encrypted using RSA-4096 asymmetric encryption with the system administrator's public key and stored in the organization's private data store, maintaining separation of public resolution records from encrypted operational audit logs.

### VI. Component 5: Regulatory Compliance Output Layer (500)

The Regulatory Compliance Output Layer, illustrated in FIG. 5 with reference numeral 500, is the fifth component of the system. It delivers resolution decisions, Provenance Tokens, and regulatory compliance records securely to authorized recipients and external platforms through a structured integration interface.

Decision Delivery (510): Formats the resolution record into a market resolution decision record specifying: the market identifier; the selected outcome; weighted vote totals per outcome; participation rate; the complete Provenance Token with all six fields; blockchain block number and timestamp of the resolution publication; and a list of quarantined submission identifiers for regulatory review.

Encryption Unit (520): Applies AES-256-GCM authenticated encryption to resolution decision records at rest, providing both confidentiality and integrity verification. Records in transit are protected using TLS 1.3 with forward secrecy. Encryption keys are managed through the TEE's key management facilities, ensuring that key material is never exposed to software outside the enclave boundary.

Compliance API (530): Exposes three defined RESTful endpoints: (a) GET/resolution/decisions/{market_id}, returning the resolution decision record and Provenance Token in JSON format with Content-Type application/json; (b) POST/resolution/verify/{market_id}, accepting a Provenance Token in the request body and returning independent attestation verification results including enclave measurement confirmation (pass/fail), ECDSA signature verification (pass/fail), monotonic counter validation (pass/fail with expected and observed values), and overall verification status; and (c) GET/resolution/audit/{market_id}, returning the complete resolution audit trail including all resolver submissions with applied weights, anomaly detection results, consensus computation records, and five supplementary transparency records comprising eligible resolver count, accepted submission count, rejected submission count, quarantined submission count, and weighted participation rate. All endpoints require API key authentication using HMAC-SHA256 signed request headers. Access logs for all endpoint invocations are generated within the TEE.

Report Formatting (540): Provides native format adapters for: (a) CFTC Part 16 regulatory reports, formatting resolution data into the daily trading and market data report structure required for Designated Contract Markets; and (b) ISO 20022 financial message formats, enabling interoperability with traditional financial infrastructure. Both format adapters produce output within the TEE, ensuring that regulatory records are generated in a tamper-resistant environment and cannot be modified after generation.

Secure Transmission (550): Transmits resolution decision records, Provenance Tokens, and regulatory reports through TLS 1.3 encrypted channels with message authentication codes (HMAC-SHA256) computed over the record payload, providing both transport encryption and payload integrity verification.

### VII. Operational Sequence

The complete operational sequence for a single market resolution cycle: (1) market resolution is initiated upon event outcome determination or resolution period expiration; (2) Resolver Influence Aggregator ingests Resolver Influence Metrics, applies min-max normalization, Privacy Filter SHA-256 pseudonymization with 256-bit salt, Source Verifier ECDSA/DID authentication, and Influence Classifier k-means clustering with k=5; (3) Influence Trust Scoring Engine computes Influence Trust Scores using the weighted aggregation formula with coefficients w_a, w_g, w_m stored in TEE sealed storage, evaluates trust level categories using the gradient-boosted tree classifier, stores computed scores as binding parameters, and assigns resolution weights in the range [0.05, 1.5]; (4) TEE Resolution Processor initializes hardware-isolated enclave, computes Enclave Measurement, generates remote attestation report, reads and verifies monotonic counter; (5) resolution period opens; resolvers submit resolution votes through smart contract function calls; (6) TEE Resolution Processor validates each submission against five predefined rules including enforcement of stored Influence Trust Scores via deterministic lookup, concurrently executes isolation forest and DBSCAN algorithms within the enclave on the resolver submission stream to quarantine anomalous submissions, applies resolution consensus (Weighted Majority, Supermajority Threshold, or Tiered Escalation) within the enclave, and generates a sealed Provenance Token comprising six cryptographic fields with ECDSA signature and monotonic counter increment; (7) Attestation and Settlement Module independently verifies the Provenance Token through four verification checks, compiles settlement instructions, publishes the resolution decision and Provenance Token to the blockchain public ledger, records blockchain timestamp, stores all records in append-only Immutable Storage using SHA-256 hashing, and encrypts the internal audit log with RSA-4096; (8) Regulatory Compliance Output Layer formats the resolution decision record, applies AES-256-GCM encryption, delivers through the three Compliance API endpoints, generates CFTC Part 16 and ISO 20022 formatted reports within the TEE, and transmits using TLS 1.3 with HMAC-SHA 256 message authentication; (9) Accuracy Feedback Loop receives verified ground-truth outcome data, computes resolution accuracy error (MSE), runs gradient-descent optimization with learning rate 0.01 over weight coefficients subject to summation and range constraints, retrains the gradient-boosted tree classifier with early stopping, and stores updated parameters in TEE sealed storage for the next resolution cycle.

### VIII. Technical Improvements Over Prior Art

The system provides the following specific technical improvements over prior art prediction market oracle systems, grounded in the architectural elements and algorithmic implementations described throughout this specification.

Improvement 1—Hardware-Attested Resolution Integrity: The TEE Resolution Processor executes all resolution computations within a hardware-isolated enclave, preventing observation or modification by platform operators, compromised node software, or co-located malicious processes. The remote attestation mechanism enables any network participant to independently verify that the resolution computation executed verified code within a genuine hardware enclave.

Improvement 2—Influence-Weighted Resolver Selection Replacing Token-Weighted Selection: The Influence Trust Scoring Engine substitutes three independently verified behavioral metrics—Resolution Accuracy Score, Governance Participation Metric, and Market Integrity Alignment Metric—for token-count weighting, eliminating plutocratic bias and ensuring resolver influence reflects demonstrated reliability rather than capital holdings.

Improvement 3—Cryptographically Sealed Provenance Tokens with Monotonic Counter Binding: Each resolution produces a six-field Provenance Token binding the decision to its inputs, model, enclave measurement, and a non-decrementable monotonic counter value, enabling post-hoc independent verification and preventing replay attacks.

Improvement 4—Concurrent Dual-Algorithm Anomaly Detection Within TEE: The concurrent execution of isolation forest and DBSCAN algorithms within the hardware-isolated enclave ensures that anomaly detection logic cannot be observed or manipulated, and that the complementary detection characteristics of the two algorithms—isolation forest for individual outlier detection and DBSCAN for coordinated cluster detection—provide broader coverage of manipulation patterns than either algorithm alone.

Improvement 5—TEE-Generated Regulatory Compliance Records: The Regulatory Compliance Output Layer generates CFTC Part 16 regulatory reports and ISO 20022 formatted records within the TEE, ensuring that regulatory compliance records are produced in a tamper-resistant environment and cannot be modified after generation.

Improvement 6—Iterative Resolver Weight Refinement Through Accuracy-Driven Feedback: The Accuracy Feedback Loop updates the influence weighting model after each resolution cycle using verified ground-truth outcomes from authorized data providers, causing resolver selection accuracy to improve over successive cycles without manual intervention.

### IX. ENABLEMENT EXAMPLES

The following examples demonstrate the complete operational sequence of the system and are provided to satisfy the enablement requirement of 35 U.S.C. § 112(a). All details are consistent with the described invention.

### Example 1

Binary Political Event Contract Resolution: A prediction market platform operating as a CFTC Designated Contract Market lists a binary contract on a presidential election outcome with two possible outcomes: Candidate A wins or Candidate B wins. The Resolver Influence Aggregator ingests Resolution Accuracy Scores from on-chain resolution histories across 50 prior political event markets, Governance Participation Metrics from resolver participation in market parameter governance over a 365-day window, and Market Integrity Alignment Metrics from correspondence between resolvers'historical resolution votes and independently verified election results from the Associated Press. The Influence Trust Scoring Engine computes Influence Trust Scores using coefficients w_a=0.50, w_g=0.25, w_m=0.25 and stores scores in TEE sealed storage; 47 resolvers meet the minimum Influence Trust Score threshold of 0.20. The TEE Resolution Processor initializes an Intel SGX enclave with MRENCLAVE =0x7a3f...b2c 1, verifies monotonic counter value 1,246 exceeds the previous cycle's value of 1,245, and opens the resolution period. Resolver submissions arrive over a 24-hour window. The isolation forest algorithm flags 3 submissions with anomaly scores of 0.82, 0.79, and 0.91, all from resolvers whose submission timing is within 200 milliseconds of each other and whose wallet creation dates are within 48 hours of each other. These 3 submissions are quarantined. The remaining 44 submissions are admitted to Weighted Majority consensus, which selects Candidate A with a weighted vote total of 38.7 out of 44.0 total weight (88.0% weighted majority). The TEE generates a Provenance Token with COUNTER_VALUE=1,247 and publishes it to the Polygon blockchain at block 58,291,043. The Attestation and Settlement Module verifies the Provenance Token, compiles settlement instructions distributing $1.00 per share to holders of Candidate A outcome shares and $0.00 to holders of Candidate B outcome shares. The Regulatory Compliance Output Layer generates a CFTC Part 16 report within the TEE and delivers it through the GET/resolution/audit/{market_id} endpoint.

### Example 2

Disputed Multi-Outcome Economic Indicator Contract with Tiered Escalation: A prediction market lists a multi-outcome contract on the quarterly GDP growth rate with four outcome brackets: below 1.0%, 1.0%-2.0%, 2.0%-3.0%, and above 3.0%. The system applies Tiered Escalation consensus. Tier 1 (automated resolution) selects the 2.0%-3.0% bracket matching the Bureau of Economic Analysis advance estimate release. Two resolvers with Influence Trust Scores of 0.87 and 0.91 submit dispute challenges within the 72-hour challenge window, citing a revision in the BEA's second estimate that moves the figure to 1.98%, placing it in the 1.0%-2.0% bracket. Tier 2 (resolver consensus) activates, collecting 31 submissions from eligible resolvers with Influence Trust Scores above the dispute threshold of 0.70. The DBSCAN anomaly detection algorithm identifies a cluster of 4 submissions from resolvers whose wallet creation timestamps, submission timing, and vote choices are statistically correlated (Jaccard similarity>0.85), flagging them as potential sybil accounts. The remaining 27 submissions achieve Supermajority Threshold consensus at 71.2% weighted vote for the 1.0%-2.0% bracket, exceeding the two-thirds threshold. The Provenance Token binds the escalated resolution to the complete input chain: the Tier 1 automated resolution, the dispute challenges, the Tier 2 resolver submissions, the anomaly detection quarantine records, and the final consensus computation. A CFTC examiner accesses the POST/resolution/verify/{market_id} endpoint with the Provenance Token, receiving confirmation that ENCLAVE_MEASUREMENT matches the Intel Attestation Service report, ECDSA SIGNATURE verifies correctly, and COUNTER_VALUE=1,248 exceeds the previous cycle's value of 1,247.

What is claimed is:

1. A computerized system configured to process and regulate oracle resolution within a prediction market distributed network to improve resolution integrity through hardware attestation, resolver selection accuracy through influence-weighted trust scoring, and resolution provenance verifiability through cryptographically sealed attestation tokens, comprising:
one or more processors including at least one processor implementing a Trusted Execution Environment (TEE) providing hardware-isolated code and data confidentiality; and
a non-transitory computer-readable memory storing instructions that, when executed by the one or more processors, cause the system to perform:
(a) aggregating, by a Resolver Influence Aggregator, Resolver Influence Metrics comprising Resolution Accuracy Scores, Governance Participation Metrics, and Market Integrity Alignment Metrics received from one or more blockchain ledgers and authorized data providers, wherein the Resolver Influence Aggregator:
replaces direct resolver identifiers with pseudonymous identifiers using SHA-256 cryptographic hashing with a system-controlled salt prior to storage or transmission of any metric data,
authenticates data origin using digital signatures or Decentralized Identifiers (DIDs) verified against a system trust registry,
applies min-max normalization to produce normalized metric values on a zero-to-one scale, and
classifies normalized metric vectors using k-means clustering to produce cluster assignments used in resolution weight computation;
(b) computing, by an Influence Trust Scoring Engine, an Influence Trust Score for each resolver by applying the weighted aggregation formula Influence_Trust_Score=(w_a×Resolution_Accuracy_Score)+(w_g×Governance_Participation_Metric)+(w_m×Market_Integrity_Alignment_Metric), and:
storing the computed Influence Trust Score in the TEE's sealed storage as a binding parameter,
programmatically enforcing the binding parameter during resolution validation such that submissions from resolvers with Influence Trust Scores below a configured minimum threshold or with resolution weights deviating from the stored Influence Trust Score are rejected prior to entry into resolution consensus, retrieving the stored Influence Trust Score during resolution validation through a deterministic lookup operation performed prior to execution of the resolution consensus, and
assigning a resolution weight in the range of 0.05 to 1.5 based on the Influence Trust Score, a trust level category of LOW, MEDIUM, HIGH, or EXPERT output by a gradient-boosted tree classifier, and a cluster-specific multiplier, wherein the weighting coefficients w_a, w_g, and w_m are updated through an Accuracy Feedback Loop that, after each completed resolution cycle, receives resolution outcome records, computes a resolution accuracy error metric, executes a gradient-descent optimization pass over the weight coefficients, and updates model parameters of the gradient-boosted tree classifier using verified ground-truth outcome data without requiring manual administrator intervention;
(c) processing, by a TEE Resolution Processor operating within a hardware-isolated Trusted Execution Environment initialized with a verified Enclave Measurement and a strictly increasing monotonic counter, resolver submissions for an active prediction market, wherein the TEE Resolution Processor:
initializes a hardware-isolated enclave, computes the Enclave Measurement as a SHA-256 hash of loaded code and data pages, generates a remote attestation report signed by the hardware manufacturer's attestation key, reads the current monotonic counter value, and verifies that the monotonic counter value is strictly greater than the value recorded for the previous resolution cycle,
validates each resolver submission against five predefined resolution rules enforced within the enclave comprising verification of resolver pseudonymous identifier registration, resolution weight consistency with the stored Influence Trust Score values retrieved by deterministic lookup, outcome vote validity against enumerated market options, digital signature verification against the resolver's registered public key, and absence of a prior submission from the same pseudonymous identifier in the active resolution cycle,
applies a resolution consensus selected from Weighted Majority, Supermajority Threshold, and Tiered Escalation with human arbitration fallback, all executing within the TEE,
concurrently executes, on the resolver submission stream prior to resolution consensus:
an isolation forest algorithm that assigns anomaly scores based on deviation from historical resolver submission patterns, and
a DBSCAN algorithm that identifies density-based clusters of correlated resolver submissions and classifies submissions outside established population clusters as potentially coordinated or sybil-originated,
wherein submissions identified as anomalous are quarantined within the enclave and excluded from consensus computation, and
generates a sealed Provenance Token comprising six fields: (i) INPUT_HASH: a SHA-256 hash of concatenated resolver submissions admitted to consensus; (ii) MODEL_HASH: a SHA-256 hash of current Influence Trust Scoring model parameters; (iii) DECISION_HASH: a SHA-256 hash of the resolution decision record; (iv) ENCLAVE_MEASUREMENT: the MRENCLAVE value computed at enclave initialization; (v) COUNTER_VALUE: the current monotonic counter value incremented after Provenance Token generation; and (vi) SIGNATURE: an ECDSA signature computed within the enclave over the concatenated hash chain SHA-256(INPUT_HASH∥MODEL_HASH∥DECISION_HASH∥ENCLAVE_MEASUREMENT∥COUNTER_VALUE) using the enclave's attestation signing key;
(d) verifying, by an Attestation and Settlement Module, the Provenance Token by confirming Enclave Measurement consistency with the remote attestation report, verifying the ECDSA signature over the concatenated hash chain, and confirming the monotonic counter value exceeds the previous resolution cycle's value, and upon successful verification: compiling settlement instructions computing payout amounts for market participants, publishing the resolution decision record and Provenance Token to a blockchain public ledger, recording a blockchain-generated timestamp derived from the block header, storing all records in append-only Immutable Storage using SHA-256 cryptographic hashing such that each record's hash is incorporated into a subsequent block header making undetected alteration computationally infeasible, and encrypting internal audit logs using asymmetric encryption with separation from published public records; and
(e) delivering, by a Regulatory Compliance Output Layer, the resolution decision record and Provenance Token through a Compliance Application Programming Interface (Compliance API) exposing three defined RESTful endpoints comprising a GET/resolution/decisions/{market_id} endpoint, a POST/resolution/verify/{market_id} endpoint, and a GET/resolution/audit/{market_id} endpoint returning five supplementary transparency records comprising eligible resolver count, accepted submission count, rejected submission count, quarantined submission count, and weighted participation rate, with API key authentication for all endpoints, wherein stored records are protected using AES-256 encryption and transmitted records are protected using TLS 1.3 encryption with message authentication code verification.

2. A computer-implemented method configured to improve prediction market oracle resolution integrity through hardware attestation and influence-weighted resolver selection, comprising:
aggregating Resolver Influence Metrics comprising Resolution Accuracy Scores, Governance Participation Metrics, and Market Integrity Alignment Metrics from one or more blockchain ledgers and authorized data providers by applying a Privacy Filter that replaces direct resolver identifiers with pseudonymous identifiers using SHA-256 cryptographic hashing with a system-controlled salt before any metric data is stored or transmitted, authenticating data origin using digital signatures or Decentralized Identifiers (DIDs) verified against a system trust registry, applying min-max normalization, and classifying normalized metric vectors using k-means clustering;
computing an Influence Trust Score for each resolver by applying the formula Influence_Trust_Score=(w_a×Resolution_Accuracy_Score)+(w_g×Governance_Participation_Metric)+(w_m×Market_Integrity_Alignment_Metric), storing the computed Influence Trust Score in a TEE's sealed storage as a binding parameter programmatically enforced in resolution validation, and assigning a resolution weight in the range of 0.05 to 1.5 based on the Influence Trust Score, a trust level category output by a trained gradient-boosted tree classifier, and a cluster-specific multiplier;
initializing a hardware-isolated Trusted Execution Environment, computing an Enclave Measurement, generating a remote attestation report, reading a monotonic counter value, and verifying the monotonic counter value is strictly greater than the previous resolution cycle's value;
processing resolver submissions within the TEE by validating each submission against five predefined resolution rules including enforcement of stored Influence Trust Score values as binding weight constraints, applying a resolution consensus selected from Weighted Majority, Supermajority Threshold, and Tiered Escalation, concurrently executing on the resolver submission stream an isolation forest algorithm and a DBSCAN algorithm wherein flagged submissions are quarantined within the enclave before consensus computation, and generating a sealed Provenance Token comprising INPUT_HASH, MODEL_HASH, DECISION_HASH, ENCLAVE_MEASUREMENT, COUNTER_VALUE, and ECDSA SIGNATURE fields;
verifying the Provenance Token, compiling settlement instructions, publishing the resolution decision and Provenance Token to a blockchain public ledger, and storing all results in append-only Immutable Storage using SHA-256 cryptographic hashing; and
delivering the resolution decision record and Provenance Token through a RESTful Compliance API providing native format adapters for CFTC Part 16 regulatory reports and ISO 20022 financial message formats, using TLS 1.3 encryption with message authentication code verification.

3. A non-transitory computer-readable storage medium storing instructions that, when executed by one or more processors including at least one processor implementing a Trusted Execution Environment, cause the processors to perform operations comprising:
aggregating Resolver Influence Metrics comprising Resolution Accuracy Scores, Governance Participation Metrics, and Market Integrity Alignment Metrics from one or more blockchain ledgers and authorized data providers by applying a Privacy Filter replacing direct resolver identifiers with pseudonymous identifiers using SHA-256 cryptographic hashing with a system-controlled salt before any metric data is stored or transmitted, and authenticating data origin using digital signatures or Decentralized Identifiers (DIDs) verified against a system trust registry;
computing an Influence Trust Score for each resolver by applying the formula Influence_Trust_Score=(w_a×Resolution_Accuracy_Score)+(w_g×Governance_Participation_Metric)+(w_m×Market_Integrity_Alignment_Metric), storing the computed Influence Trust Score as a binding parameter in the TEE's sealed storage, and assigning a resolution weight in the range of 0.05 to 1.5 based on the Influence Trust Score and a cluster assignment produced by k-means clustering of normalized metric vectors;
initializing a hardware-isolated Trusted Execution Environment with Enclave Measurement computation, remote attestation, and monotonic counter verification;
processing resolver submissions within the TEE by validating each submission against five predefined resolution rules including enforcement of stored Influence Trust Scores, applying a resolution consensus, concurrently executing on the resolver submission stream an isolation forest algorithm and a DBSCAN algorithm wherein flagged submissions are quarantined before consensus computation, and generating a sealed Provenance Token comprising INPUT_HASH, MODEL_HASH, DECISION_HASH, ENCLAVE_MEASUREMENT, COUNTER_VALUE, and ECDSA SIGNATURE fields;
verifying the Provenance Token, compiling settlement instructions, publishing five supplementary transparency records comprising eligible resolver count, accepted submission count, rejected submission count, quarantined submission count, and weighted participation rate to a blockchain public ledger, and storing all results in append-only Immutable Storage using SHA-256 cryptographic hashing; and
delivering a resolution decision record and Provenance Token through a RESTful Compliance API with TLS 1.3 encryption.

4. The system of claim 1, wherein the Resolution Accuracy Score comprises a numerical value derived from verifiable on-chain resolution histories including the ratio of correctly resolved markets to total markets participated in, weighted by market liquidity measured in total traded volume and recency measured as an exponential decay function with a configurable half-life; the Governance Participation Metric comprises a numerical value derived from the frequency, recency, and quality of governance interactions including dispute resolution participation, market parameter voting, and protocol upgrade contributions over a preceding configurable time window; and the Market Integrity Alignment Metric comprises a numerical value derived from the degree of correspondence between the resolver's past resolution decisions and independently verified ground-truth outcomes recorded by authorized data providers.

5. The system of claim 1, wherein the Resolver Influence Aggregator further comprises a Source Verifier that, for on-chain metric data, retrieves the relevant blockchain transaction record and verifies the transaction signature against the originating account's public key, and for off-chain metric data from authorized data providers, requires a Decentralized Identifier (DID) credential signed by an authorized certification authority whose public key is registered in a system trust registry, and rejects and logs as unauthenticated any record failing signature verification or whose DID credential is not found in the trust registry.

6. The system of claim 1, wherein the TEE Resolution Processor applies a Tiered Escalation resolution consensus comprising: an automated resolution tier that selects the outcome matching data from an authorized data provider; a resolver consensus tier activated upon dispute challenge from at least one resolver with an Influence Trust Score above a configured dispute threshold; and a human arbitration escalation tier activated when resolver consensus fails to reach a supermajority threshold of at least two-thirds of weighted resolver votes within a configured time window.

7. The system of claim 1, wherein the Attestation and Settlement Module's Attestation Verification step independently verifies the Provenance Token by: retrieving the enclave's remote attestation report from the hardware manufacturer's attestation service; confirming that the ENCLAVE_MEASUREMENT in the Provenance Token matches the measurement in the attestation report; verifying the ECDSA SIGNATURE over the concatenated hash chain using the enclave's public attestation key; and confirming that the COUNTER_VALUE is strictly greater than the value recorded for the previous resolution cycle, and wherein settlement execution proceeds only if all four verification checks pass.

8. The system of claim 1, wherein the Compliance API exposes: a GET/resolution/decisions/{market_id} endpoint returning the resolution decision record and Provenance Token in JSON format; a POST/resolution/verify/{market_id} endpoint accepting a Provenance Token and returning independent attestation verification results including enclave measurement confirmation, ECDSA signature verification, and monotonic counter validation; and a GET/resolution/audit/{market_id} endpoint returning the complete resolution audit trail and five supplementary transparency records; wherein access to all endpoints requires authentication using an API key issued by a system administrator.

9. The system of claim 1, wherein the Accuracy Feedback Loop, after each completed resolution cycle: receives resolution outcome records comprising resolver submissions, applied resolution weights, and a verified ground-truth outcome from authorized data providers; computes a resolution accuracy error metric measuring divergence between the influence-weighted consensus outcome and the verified ground-truth; executes a gradient-descent optimization pass over the weight coefficients w_a, w_g, and w_m to minimize the accuracy error metric; updates model parameters of the gradient-boosted tree classifier using the resolution outcome training data; and stores updated model parameters in the TEE's sealed storage without requiring manual administrator intervention.

10. The method of claim 2, wherein computing the Influence Trust Score further comprises classifying each resolver into a trust level category of LOW, MEDIUM, HIGH, or EXPERT using a trained gradient-boosted tree classifier, and applying a default base weight of 0.1 for LOW, 0.4 for MEDIUM, 0.8 for HIGH, and 1.0 for EXPERT, wherein the base weight is further adjusted by a cluster-specific multiplier learned through iterative Accuracy Feedback Loop training using gradient-descent optimization over resolution outcome data to produce a final resolution weight in the range of 0.05 to 1.5.

11. The method of claim 2, wherein the Privacy Filter, before storing or transmitting any metric data record, suppresses metric values below a configured minimum aggregation threshold to prevent individual-level inference, and stores a mapping between pseudonymous identifiers and actual resolver identities within the TEE's sealed storage accessible only through attested enclave operations.

12. The method of claim 2, wherein processing resolver submissions further comprises executing all resolution computations within a hardware-isolated Trusted Execution Environment implementing Intel Software Guard Extensions (SGX) or ARM TrustZone, wherein the operating system, hypervisor, and other software outside the enclave boundary cannot observe or modify resolution computation state.

13. The method of claim 2, wherein generating the sealed Provenance Token further comprises: computing INPUT_HASH as a SHA-256 hash of the concatenated resolver submissions admitted to consensus; computing MODEL_HASH as a SHA-256 hash of the current Influence Trust Scoring model parameters stored in TEE sealed storage; computing DECISION_HASH as a SHA-256 hash of the resolution decision record including selected outcome and weighted vote totals; reading ENCLAVE_MEASUREMENT from the enclave initialization record; reading COUNTER_VALUE from the hardware monotonic counter; incrementing the hardware monotonic counter; and computing SIGNATURE as an ECDSA signature over SHA-256(INPUT_HASH∥MODEL_HASH∥DECISION_HASH∥ENCLAVE_MEASUREMENT∥COUNTER_VALUE) using the enclave's attestation signing key.

14. The method of claim 2, further comprising, after the resolution cycle closes, automatically updating model parameters of the gradient-boosted tree classifier by: receiving verified ground-truth outcome records; computing a resolution accuracy error metric; executing a gradient-descent optimization pass over the weight coefficients w_a, w_g, and w_m; updating model parameters of the gradient-boosted tree classifier using the new training data; and storing updated model parameters in the TEE's sealed storage without requiring manual administrator intervention.

15. The non-transitory computer-readable storage medium of claim 3, wherein delivering the resolution decision record further comprises formatting regulatory compliance records using a native format adapter compatible with CFTC Part 16 regulatory report requirements or ISO 20022 financial message formats, and transmitting the formatted record through a TLS 1.3 encrypted channel with a message authentication code computed over the record payload.

16. The system of claim 1, wherein the Trusted Execution Environment implements Intel Software Guard Extensions (SGX) and the Enclave Measurement is computed as the MRENCLAVE value, and the remote attestation report is signed using the Intel Enhanced Privacy ID (EPID) or Data Center Attestation Primitives (DCAP) attestation protocol.

17. The system of claim 1, wherein the Anomaly Detection submodule executes the isolation forest algorithm and the DBSCAN algorithm concurrently within the hardware-isolated TEE, ensuring that anomaly detection logic, trained model parameters, and anomaly score thresholds cannot be observed or manipulated by processes outside the enclave boundary.

18. The method of claim 2, wherein the resolution consensus further comprises computing settlement instructions within the TEE such that winning outcome shares settle at one dollar per share and losing outcome shares settle at zero, and wherein the settlement instructions are signed within the enclave and published to the blockchain with the Provenance Token.

19. The system of claim 1, wherein the monotonic counter is a hardware-enforced counter implemented within the Trusted Execution Environment that increments with each resolution execution and cannot be decremented or reset by software, firmware, or operating system processes, and wherein the system aborts enclave initialization and logs a replay attack alert if the current monotonic counter value is not strictly greater than the value recorded for the previous resolution cycle.

20. The system of claim 1, wherein the system is configured to operate as resolution infrastructure for a Designated Contract Market registered with the U.S. Commodity Futures Trading Commission (CFTC), and wherein the Compliance API generates regulatory compliance records formatted for CFTC Part 16 reporting requirements within the hardware-isolated TEE, ensuring that regulatory records are produced in a tamper-resistant environment and cannot be modified after generation.
